(19) United States
(12) Patent Application Publication
(10) Pub. No.: US 2018/0108063 A1
(43) Pub. Date: Apr. 19, 2018

(54) System for Managing Information about the Content in a Container

(71) Applicant: Kwei Meng Yap, Houston, TX (US)

(72) Inventor: Kwei Meng Yap, Houston, TX (US)

(21) Appl. No.: 15/292,965

(22) Filed: Oct. 13, 2016

(51) Int. Cl. G06Q 30/06; G06K 19/06; G06K 7/14

(52) U.S. Cl. CPC G06Q 30/0623; G06K 7/1447; G06K 7/1417; G06K 19/06037

(57) ABSTRACT

Provided are systems for managing information of the content stored in a container. The system comprises a container, a scannable code disposed on the container, a smart device comprising a camera, processor, a memory and a display. A library of algorithms is tangibly stored in the memory. These algorithms comprise processor-executable instructions to obtain the information of the content in the container via the scannable code and enable user to input information of the content in the container to the scannable code. Also provided is a user-implemented method for notifying an individual about an expiration date of a foodstuff in which an expiration date is inputted and associated with the scannable code and a reminder notification is generated and displayed when the date is reached.

### BACKGROUND OF THE INVENTION

### Field of the Invention

The present invention generally relates to the field of storage containers. More specifically, the present invention relates to container with a scannable bar code or a string code printed or affixed thereon coupled with an application in a smart device.

### Description of the Related Art

Containers are widely used for storage of foodstuffs or other commodities in our daily lives. However, using numerous containers for similar items often causes confusion for users to keep track of the content stored in them or to correctly identify them. Especially, for time sensitive items, such as food, losing track of the expiration date may cause health hazards for the users. Quickly identifying expired goods in these containers is imperative for health and safety reasons. Moreover, other information about the content stored inside containers may be necessary or desirable for the user to obtain quickly, such as key ingredients of the food in the containers. Such would be useful, for example, in identifying the flavor of the food or identifying whether the food would cause allergies for the user.

Traditionally, paper labels are widely used for indicating the information about the contents stored in these containers. However, labels often need to be stuck onto the container, resulting in difficulty when removing it when a new label is needed. On the other hand when the label is not firmly stuck to the container, this often results in loss of the label during daily use of the container. Furthermore, traditional paper labels normally have limited space on which to put information, such as the names of the ingredients. To enter more information on the label requires larger sized labels and writing down the information by hand, thereby causing unnecessary inconvenience.

Therefore, there is a recognized need in the art for a system that can quickly access, retrieve, read, update and enter or edit information on the contents in storage containers without physically replacing paper labels. Particularly, the previous art is deficient in this aspect. The present invention fulfills this long-standing need and desire in the art.

### SUMMARY OF THE INVENTION

The present invention is directed to a system for managing information of content in a container. The system comprises the container, a scannable code electronically associated with the information disposed on the container, a smart device comprising a camera, processor, a memory and a display. A library of algorithms is tangibly stored in the memory. These algorithms are executable by the processor via processor-executable instruction to obtain the information of the content in the container via the scannable code and enable user to input information of the content in the container to the scannable code.

The present invention also is directed to a system for tracking the information about content in a container. The system comprises the container, a scannable code electronically associated with the information disposed on the container, a smart device comprising a camera, processor, a memory and a display. A library of algorithms is tangibly stored in the memory and is executable by the processor. The algorithms are configured to retrieve the information associated with the scannable code via an image of the code captured by the camera or entering a string code in the smart device, enable a user to edit the retrieved information or enter the new information of the scannable code and set a reminder notification.

The present invention is directed further to a user-implemented method for managing information about content in a container. In the method the system as described herein is accessed and the user scans the scannable code on the container with the smart device. Information about the content in the container associated with the scannable code is retrieved. An input window on the smart device is opened and the user edits the retrieved information or enters new information comprising a reminder for a date entered by the user via the input window. The user saves the edited information or the new information entered into the input window and a reminder notification is sent on the date entered by the user.

The present invention is directed further still to a user-implemented method for notifying an individual about an expiration date of a foodstuff. The method comprises storing the foodstuff in a container comprising an electronically scannable code. Then, the scannable code is scanned with a camera on a smart device. The scannable code is identified via a library of processor-executable algorithms tangibly stored in a memory of the smart device. An expiration date for the foodstuff is input into the scannable code. A reminder notification is generated and displayed on the smart device when the expiration date is reached, thereby notifying the individual. The present invention is directed to a related method comprising a further step of inputting other information about the foodstuff in the container into the scannable code. The present invention is directed to another related method comprising further steps of retrieving via the library of algorithms the inputted expiration date or other information associated with the scannable code and updating the expiration date or other information.

### BRIEF DESCRIPTION OF THE DRAWINGS

So that the matter in which the above-recited features, advantages and objects of the invention, as well as others that will become clear, are attained and can be understood in detail, more particular descriptions of the invention briefly summarized above may be by reference to certain embodiments thereof that are illustrated in the appended drawings. These drawings form a part of the specification. It is to be noted, however, that the appended drawings illustrate preferred embodiments of the invention and therefore are not to be considered limiting in their scope.

FIG. 1 depicts the smart device camera is being used to scan the scannable code on the container.

FIG. 2 depicts the smart device camera is being used to scan the scannable code on a feeding bottle.

FIG. 3 depicts the container used in the system with a scannable code and a string code printed thereon.

FIG. 4 depicts that the container used in the system is a feeding bottle with a scannable code and a string code printed thereon.

FIGS. 5A-5C depicts the user interfaces of the algorithm. FIG. 5A shows the interface for the main menu for interface of the algorithm. FIG. 5B shows the interface for scanning the scannable code on the container. FIG. 5C depicts an exemplary window for displaying the information retrieved from the container or feeding bottle via the scannable code or string code.

FIG. 6 is schematic chart showing the relationships of the processor, the memory and the library of algorithms of the smart device.

FIG. 7 is a flowchart for the method of using the system for tracking the content in the container.

### DETAILED DESCRIPTION OF THE INVENTION

As used herein in the specification, “a” or “an” may mean one or more. As used herein in the claim(s), when used in conjunction with the word “comprising”, the words “a” or “an” may mean one or more than one.

As used herein “another” or “other” may mean at least a second or more of the same or different claim element or components thereof. Similarly, the word “or” is intended to include “and” unless the context clearly indicates otherwise. “Comprise” means “include.”

As used herein, the term “about” refers to a numeric value, including, for example, whole numbers, fractions, and percentages, whether or not explicitly indicated. The term “about” generally refers to a range of numerical values (e.g., +/−5-10% of the recited value) that one of ordinary skill in the art would consider equivalent to the recited value (e.g., having the same function or result). In some instances, the term “about” may include numerical values that are rounded to the nearest significant figure.

As used herein, the term “container” refers to a basic storage tool comprising any device creating a partially or fully enclosed or enclosable space that is used to contain, store, and transport foodstuffs or other materials in a solid, liquid or gaseous form. Examples of the “container” include, but are not limited to, a lunch box, a bag, a baggie, a tote, a utility box, a canister, a jar, or a bottle.

In one embodiment of the present invention, there is provided a system for managing information about content stored in a container, comprising the container; a scannable code electronically associated with the information disposed on the container; a smart device comprising a camera, processor, a memory, and a display; a library of algorithms tangibly stored in the memory and executable by the processor, said algorithms configured to identify the scannable code via the processor-executable instructions that function to retrieve the content information via the scannable code; and enable a user to input information of the content in the container to the scannable code. In this embodiment, the content stored in the container is perishable. Preferably, the content may be a foodstuff.

In this embodiment, the scannable code may be a two-dimensional barcode or a linear barcode. The representative smart device may include but are not limited to a smart phone or a tablet computer. In this embodiment, the exemplary information of the content in the container include but are not limited to a name of the content, an expiration time, time of a scan, note about the content or a combination thereof. Further in this embodiment, the processor-executable instructions are further configured to generate a reminder notification at the expiration time.

In another embodiment of the present invention, there is provided a user-implemented method for managing information of content in a container, comprising steps of accessing the system described above; user-scanning the scannable code on the container with the smart device; retrieving information about the content in the container associated with the scannable code; opening an input window on the smart device; user-editing the retrieved information or entering new information comprising a reminder on a date entered by the user via the input window; user-saving the information entered into the input window; and sending a reminder notification on the date entered by the user.

In yet another embodiment of the present invention, there is provided a system for tracking the information about content in a container. The system comprises the container; a scannable code electronically associated with the information disposed on said container; a smart device comprising a camera, processor, a memory and a display; a library of algorithms tangibly stored in the memory and executable by the processor configured to retrieve the information associated with the scannable code via an image of said scannable code captured by the camera, to enable a user to edit the retrieved information, and to set a date for a reminder notification.

In this embodiment, the scannable code is a two-dimensional barcode or a linear barcode. The smart device may be a smart phone or a tablet computer. In this embodiment, the exemplary information of the content in the container include but are not limited to a name of the content, an expiration time, time of a scan, note about the content or a combination thereof.

In yet another embodiment of the present invention, there is provided a user-implemented method for notifying an individual about an expiration date of a foodstuff comprising storing the foodstuff in a container comprising an electronically scannable code; scanning the scannable code with a camera on a smart device; identifying the scannable code via a library of processor-executable algorithms tangibly stored in a memory of the smart device; inputting an expiration date for the foodstuff into the scannable code; and generating and displaying a reminder notification on the smart device when the expiration date is reached, thereby notifying the individual.

Further to this embodiment, the method may comprise inputting other information about the foodstuff in the container into the scannable code. In this further embodiment, examples of the other information include but are not limited to a name of the foodstuff, time of a scan, a note about the foodstuff or a combination thereof.

In another further embodiment, the method may comprise retrieving via the library of algorithms the inputted expiration date or other information associated with the scannable code and updating the expiration date or other information.

In all embodiments, the scannable code may be a two-dimensional barcode or a linear barcode. Also, the smart device may be, but is not limited to, a smart phone or a tablet computer.

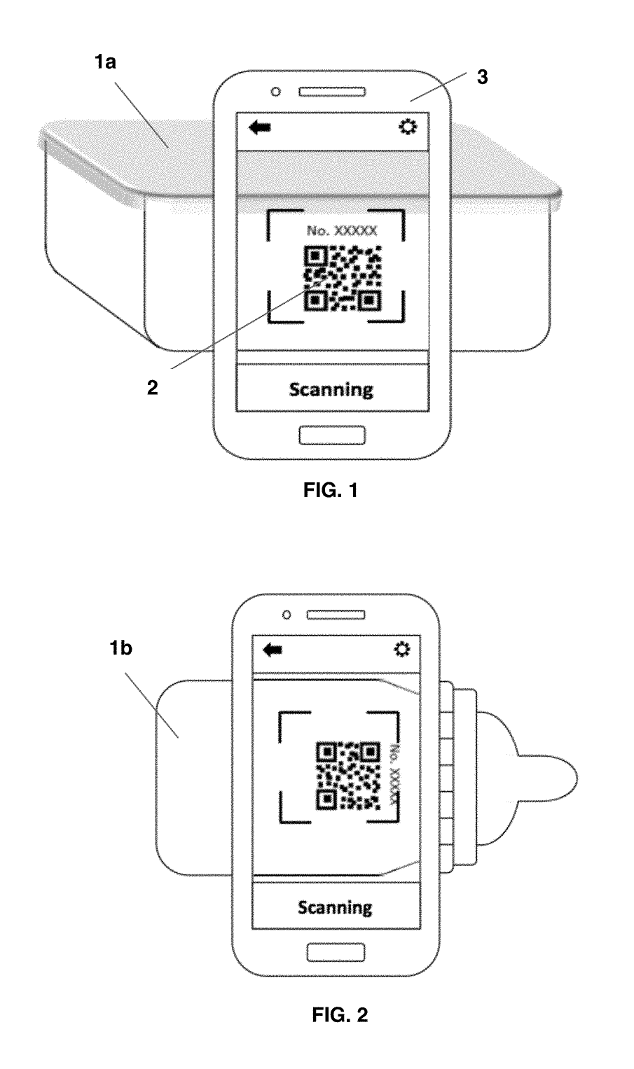

Provided herein are systems and methods for managing the information of the content stored in a container. Generally, as shown in FIG. 1, the system comprises a container 1a, a scannable code 2 on the container, a smart device 3 with a processor, a memory, a camera and a display. The scannable code may be permanently printed on the container or may be disposed thereon using an adhesive. Particularly, the system can be used for tracking the expiration date of perishable content stored in the container. Exemplary perishable contents include but are not limited to foodstuffs, biological media for laboratory use and other solutions of chemical or biological compounds. Preferably, the foodstuff is for human consumption although the methods and systems described herein are applicable to an animal feed.

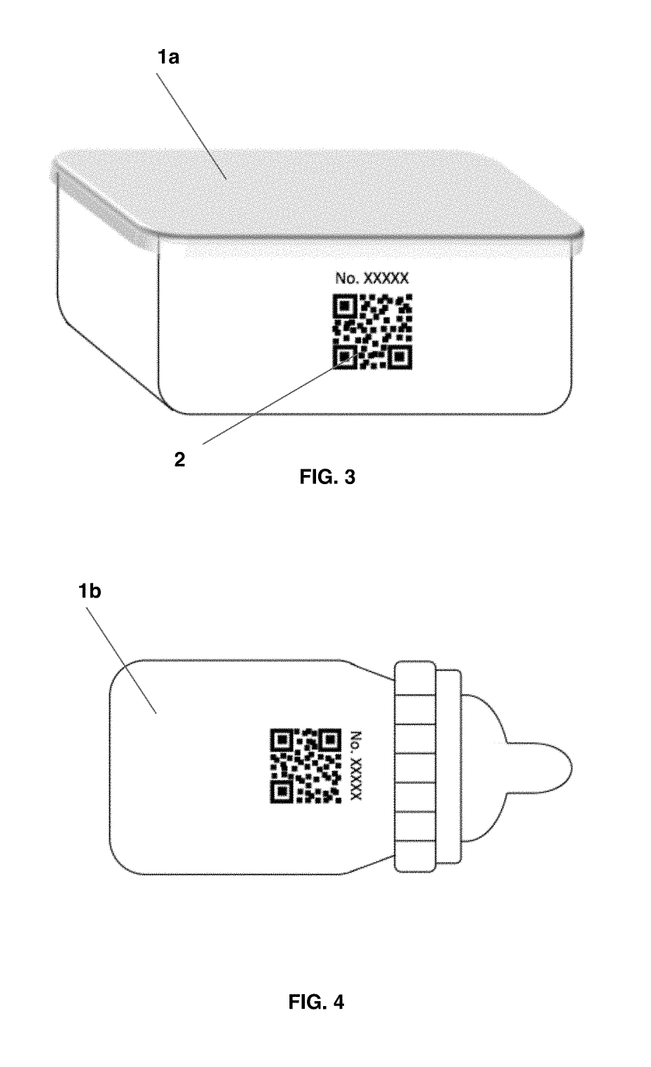

FIG. 2 shows that the container in the system is a feeding bottle 1b, for which the system can provide accurate information about the content therein, and can send notification at the time the milk or baby formula is not safe for consumption. A library of algorithms is tangibly stored in the smart device. These algorithms are configured to scan the scannable code via the camera, retrieve the information from the scannable code and display it on an information window, and enable the user to enter or edit the information via the information window. FIG. 3 shows that the container 1a may comprise a string code, a scannable code, a linear code or a combination thereof for retrieving and editing the information of the content in the container via smart device.

FIG. 4 shows that the container may be a feeding bottle 1b with a string code, a scannable code, or a combination thereof thereon 2.

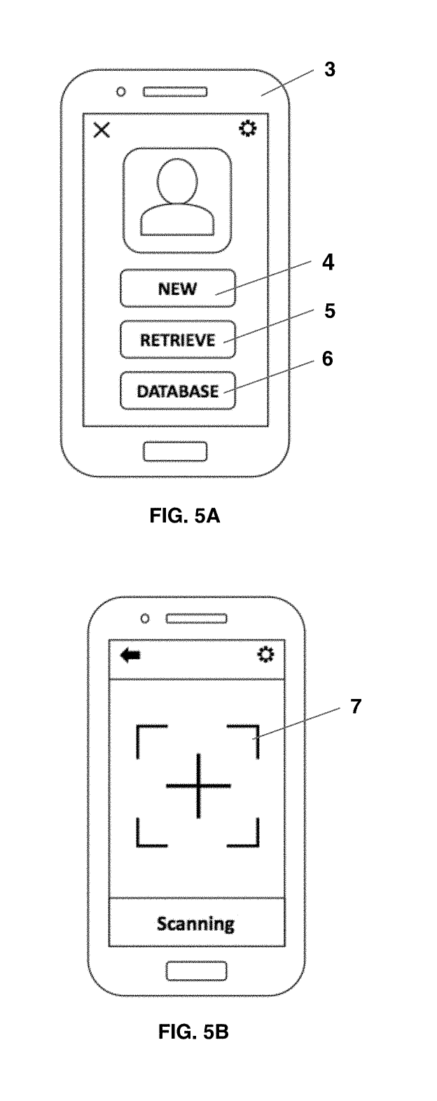

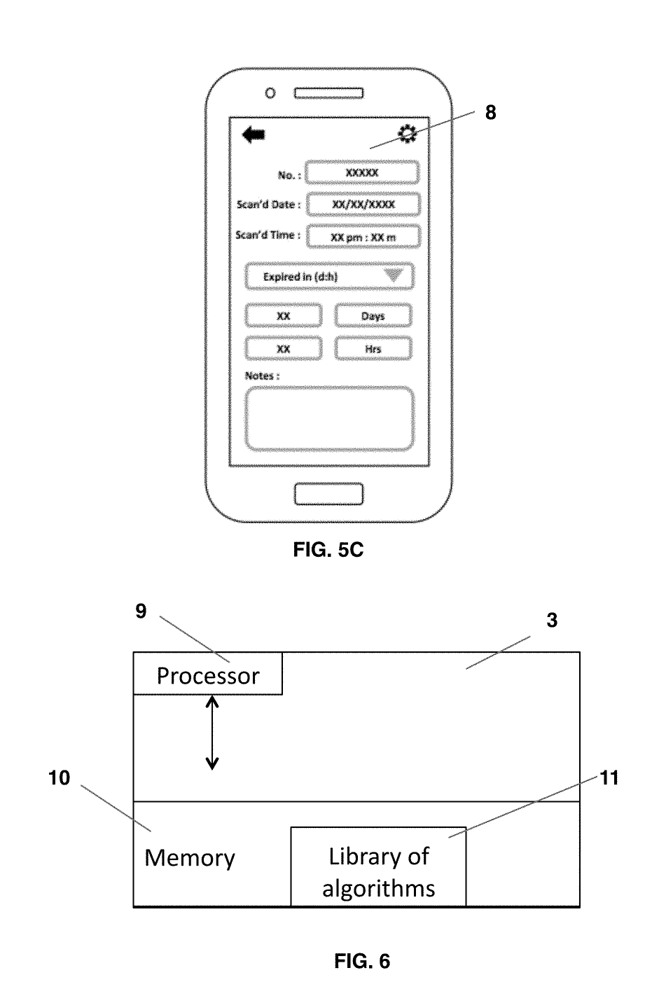

FIGS. 5A-5C shows the user interface of the system on the smart device. FIG. 5A shows the interface for the main menu of the algorithm comprising an icon for new information for the content 4, an icon for retrieving information from the scannable code or string code on the container or feeding bottle 5, and an icon for accessing the database for all the information about the contents in the container or feeding bottle 6. FIG. 5B shows the interface for scanning the scannable code on the container via the camera on the smart device comprising a frame 7 for user to fit the scannable code therein. FIG. 5C shows an exemplary window 8 for displaying the information retrieved from the container or feeding bottle via the smart device, comprising the code, scanned date, scanned time, expiring time, and a note section. The information for the content in the container or feeding bottle may further comprise photos for the content.

FIG. 6 shows the schematic relationships of the processor 9, the memory 10 and the library of the algorithms 11 in the smart device 3. In general, the processor reads and writes information into the memory. The library of algorithms 11 is tangibly stored in the memory of the smart device.

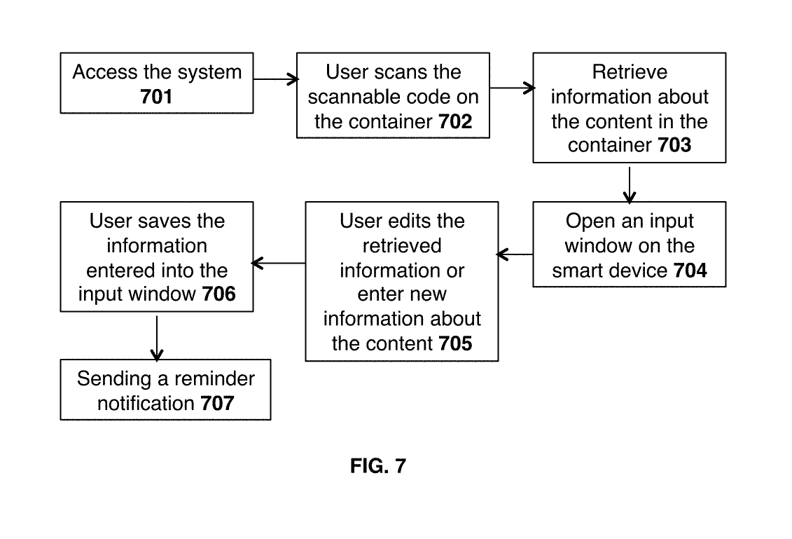

FIG. 7 is a flowchart of the method of using the system for tracking the content in the container. First, the user accesses the system described above 701. The user then scans the scannable code on the container with the smart device 702. The information about the content in the container associated with the scannable code is retrieved 703. An input window is shown on the screen of the smart device 704. The user then edits the retrieved information comprising a reminder about a date entered by the user or enters new information via the input window 705. The user saves the information 706. The system generates and displays a reminder notification on the date entered by the user 707.

The present invention is well adapted to attain the ends and advantages mentioned as well as those that are inherent therein. The particular embodiments disclosed above are illustrative only, as the present invention may be modified and practiced in different but equivalent manners apparent to those skilled in the field having the benefit of the teachings herein. Furthermore, no limitations are intended to the details of construction or design herein shown, other than as described in the claims below. It is therefore evident that the particular illustrative embodiments disclosed above may be altered or modified and all such variations are considered within the scope and spirit of the present invention.

1: A system for managing information about content stored in a container, consisting of:
the container;
a scannable two-dimensional barcode electronically associated with the information disposed on said container;
a string code disposed on the container electronically associated with the information;
a smart device comprising a camera, processor, a memory, a display, and a network connection;
a library of algorithms tangibly stored in the memory and executable by the processor, said algorithms configured to identify the string code and the scannable code via the processor-executable instructions that function to:
retrieve the content information via the string code and the scannable code; and
enable a user to input information about the content and associate it with the string code and the scannable code.

2: The system of claim 1, wherein the content stored in the container is perishable.

3: The system of claim 2, wherein the content stored in the container is a foodstuff.

4. (canceled)

5: The system of claim 1, wherein the smart device is a smart phone or a tablet computer.

6: The system of claim 1, wherein said content information comprises a name of the content, an expiration time, time of a scan, a note about the content or a combination thereof.

7: The system of claim 6, wherein the processor-executable instructions are further configured to generate and display a reminder at said expiration time.

8: A user-implemented method for managing information about content in a container, comprising steps of:
accessing the system of claim 1;
user-scanning the scannable two-dimensional barcode on the container with the smart device or user-entering the string code into the smart device;
retrieving information about the content in the container associated with the scannable two-dimensional barcode or the string code;
opening an input window on the smart device;
user-editing the retrieved information or entering new information comprising a reminder for a date entered by the user via the input window;
user-saving the edited information or the new information entered into the input window; and
sending a reminder notification on the date entered by the user.

9: A system for tracking information about content in a container, consisting of:
the container;
a scannable two-dimensional barcode electronically associated with the information disposed on said container;
a string code disposed on said container electronically associated with the information and;
a smart device comprising a camera, processor, a memory, a display, and a network connection
a library of algorithms tangibly stored in the memory and executable by the processor configured to retrieve the information associated with the string code and the scannable two-dimensional barcode via input of said string code into the smart device or via an image of said scannable two-dimensional barcode captured by the camera, to enable a user to edit the retrieved information, and to set a date for a reminder notification.

10. (canceled)

11: The system of claim 9, wherein the smart device is a smart phone or a tablet computer.

12: The system of claim 9, wherein said content information comprises a name of the content, an expiration time, time of a scan, a note about the content or a combination thereof.

13: A user-implemented method for notifying an individual about an expiration date of a foodstuff, comprising:
storing the foodstuff in a container comprising a string code;
accessing the system of claim 9;
entering the string code into the smart device;
retrieving information associated with the string code via the library of processor-executable algorithms;
editing the retrieved information to include an expiration date for the foodstuff and a date for a reminder notification; and
generating and displaying the reminder notification on the smart device when the expiration date is reached, thereby notifying the individual.

14: The method of claim 13, further comprising:
editing the retrieved information to include other information about the foodstuff in the container.

15: The method of claim 14, wherein the other information comprises a name of the foodstuff, time of a scan, a note about the foodstuff or a combination thereof.

16: The method of claim 14, further comprising:
retrieving via the library of algorithms the edited information; and
updating the expiration date or other information.

17-18. (canceled)
